(19) United States
(12) Patent Application Publication
(10) Pub. No.: US 2024/0113363 A1
(43) Pub. Date: Apr. 4, 2024

(54) SYSTEMS AND METHODS FOR ATTACHING PERIPHERAL COMPONENTS TO TRACTION BATTERY PACKS

(71) Applicant: FORD GLOBAL TECHNOLOGIES, LLC, Dearborn, MI (US)

(72) Inventors: Parikshit GUPTE, West Bloomfield, MI (US); Alexander Robert RINK, Royal Oak, MI (US); Nathaniel CONTI, Canton, MI (US); Benjamin STUMPF, Livonia, MI (US)

(21) Appl. No.: 17/936,886

(22) Filed: Sep. 30, 2022

(51) Int. Cl. H01M 50/166; H01M 50/264

(52) U.S. Cl. CPC H01M 50/166; H01M 50/264; H01M 2220/20

(57) ABSTRACT

Traction battery pack designs are disclosed for use in electrified vehicles. Exemplary traction battery packs may include an outer enclosure assembly establishing an interior, and a battery array housed within the interior. A peripheral component assembly may be secured within a wall of the outer enclosure assembly. The wall may be part of a tray or a cover of the outer enclosure assembly. The peripheral component assembly may include twist lock features for rotatably securing the peripheral component assembly in place within a mounting opening of the wall. Using the twist lock features, the peripheral component assembly may be installed from inside the outer enclosure assembly.

### TECHNICAL FIELD

This disclosure relates generally to electrified vehicle traction battery packs, and more particularly to systems and methods for installing peripheral components from an inside of the traction battery pack enclosure.

### BACKGROUND

A high voltage traction battery pack typically powers an electric machine and other electrical loads of an electrified vehicle. The traction battery pack includes a plurality of battery cells and various other battery internal components that are housed inside an outer enclosure assembly for supporting the electric propulsion of the vehicle. Various peripheral components (e.g., valves, bulkheads, fittings, etc.) may be attached to the outer enclosure assembly of the traction battery pack.

### SUMMARY

A traction battery pack according to an exemplary aspect of the present disclosure includes, among other things, an outer enclosure assembly including a wall, and a peripheral component assembly rotatably secured within a mounting opening of the wall. The peripheral component assembly includes a backing plate that interfaces with an interior surface of the wall and a twist lock that interfaces with an exterior surface of the wall.

In a further non-limiting embodiment of the foregoing traction battery pack, the wall is part of an enclosure tray of the outer enclosure assembly.

In a further non-limiting embodiment of either of the foregoing traction battery packs, the wall is part of an enclosure cover of the outer enclosure assembly.

In a further non-limiting embodiment of any of the foregoing traction battery packs, the peripheral component assembly is rotatable between an alignment position and an engagement position relative to the mounting opening.

In a further non-limiting embodiment of any of the foregoing traction battery packs, in the alignment position, a mounting tab of the twist lock is received within a slot of the mounting opening.

In a further non-limiting embodiment of any of the foregoing traction battery packs, the slot extends radially outward of an outer circumference of the mounting opening.

In a further non-limiting embodiment of any of the foregoing traction battery packs, in the engagement position, the mounting tab is angularly displaced from the slot and is positioned to engage the exterior surface of the wall.

In a further non-limiting embodiment of any of the foregoing traction battery packs, a gap between the backing plate and a mounting tab of the twist lock is equal to a thickness of the wall.

In a further non-limiting embodiment of any of the foregoing traction battery packs, a plurality of assembly aids protrude from the backing plate.

In a further non-limiting embodiment of any of the foregoing traction battery packs, the backing plate includes a groove, and a face seal is received within the groove and configured to seal an interface between the backing plate and the interior surface of the wall.

In a further non-limiting embodiment of any of the foregoing traction battery packs, a block-off plate is removably secured to the backing plate.

In a further non-limiting embodiment of any of the foregoing traction battery packs, the twist lock is located radially outward of a peripheral component body of the peripheral component assembly.

In a further non-limiting embodiment of any of the foregoing traction battery packs, at least a portion of the peripheral component body extends outward of the exterior surface of the wall.

In a further non-limiting embodiment of any of the foregoing traction battery packs, a battery array is housed within an interior established by the outer enclosure assembly.

In a further non-limiting embodiment of any of the foregoing traction battery packs, the backing plate is closer to the battery array than the twist lock when the peripheral component assembly is secured within the mounting opening.

A method according to another exemplary aspect of the present disclosure includes, among other things, positioning a peripheral component assembly relative to an interior surface of a wall of an outer enclosure assembly of a traction battery pack, aligning a twist lock of the peripheral component assembly to a slot of a mounting opening of the wall, moving the twist lock through the slot, and rotating the peripheral component assembly to cause the twist lock to engage an exterior surface of the wall.

In a further non-limiting embodiment of the forgoing method, after the rotating, a mounting tab of the twist lock is angularly displaced relative to the slot.

In a further non-limiting embodiment of either of the foregoing methods, before the rotating, the mounting tab is aligned with the slot.

In a further non-limiting embodiment of any of the foregoing methods, moving the twist lock through the slot includes moving the peripheral component assembly in an inside-to-outside direction relative to an interior of the outer enclosure assembly.

In a further non-limiting embodiment of any of the foregoing methods, moving the peripheral component assembly includes positioning a backing plate of the peripheral component assembly in abutting contact with the interior surface of the wall.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 is a perspective view of another exemplary traction battery pack.

FIG. 4 is a cross-sectional view through section 4-4 of FIG. 2 and illustrates features associated with a peripheral component assembly that can be secured to an outer enclosure assembly of the traction battery pack.

FIG. 5 is an end view of the peripheral component assembly of FIG. 4.

FIG. 6 illustrates portions of a wall of an outer enclosure assembly of a traction battery pack.

FIG. 7 illustrates a peripheral component assembly installed within an opening of the wall of FIG. 6.

### DETAILED DESCRIPTION

This disclosure details exemplary traction battery pack designs for use in electrified vehicles. Exemplary traction battery packs may include an outer enclosure assembly establishing an interior, and a battery array housed within the interior. A peripheral component assembly may be secured within a wall of the outer enclosure assembly. The wall may be part of a tray or a cover of the outer enclosure assembly. The peripheral component assembly may include twist lock features for rotatably securing the peripheral component assembly in place within a mounting opening of the wall. Using the twist lock features, the peripheral component assembly may be installed from inside the outer enclosure assembly. These and other features are discussed in greater detail in the following paragraphs of this detailed description.

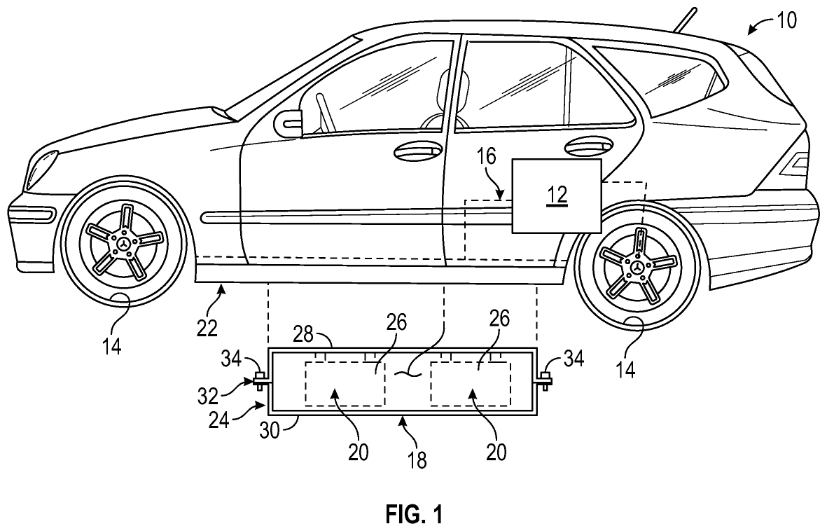

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In the illustrated embodiment, the electrified vehicle 10 is a sport utility vehicle (SUV). However, the electrified vehicle 10 could alternatively be a car, a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10

A voltage bus 16 may electrically couple the electric machine 12 to a traction battery pack 18. The traction battery pack 18 is an exemplary electrified vehicle battery. The traction battery pack 18 may be a high voltage traction battery pack that includes one or more battery arrays 20 (i.e., battery assemblies or groupings of rechargeable battery cells 26) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 26 may be stacked side-by-side along a stack axis to construct a grouping of battery cells 26, sometimes referred to as a “cell stack.” In the highly schematic depiction of FIG. 1, the battery cells 26 are stacked in a direction into the page to construct each battery array 20, and thus the battery arrays 20 extend in cross-car direction. However, other configurations may also be possible.

The total number of battery arrays 20 and battery cells 26 provided within the traction battery pack 18 is not intended to limit this disclosure. In an embodiment, the battery cells 26 of each battery array 20 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The traction battery pack 18 may be secured to an underbody 22 of the electrified vehicle 10. However, the traction battery pack 18 could be located elsewhere on the electrified vehicle 10 within the scope of this disclosure.

An outer enclosure assembly 24 may house each battery array 20 of the traction battery pack 18. The outer enclosure assembly 24 may be a sealed enclosure and may embody any size, shape, and configuration within the scope of this disclosure. In an embodiment, the outer enclosure assembly 24 includes an enclosure cover 28 and an enclosure tray 30. Together, the enclosure cover 28 and the enclosure tray 30 may establish an interior I for housing the battery arrays 20 and other battery internal components (e.g., bussed electrical center, battery electric control module, wiring, connectors, etc.) of the traction battery pack 18.

During assembly of the traction battery pack 18, the enclosure cover 28 may be secured to the enclosure tray 30 at an interface 32 therebetween. The interface 32 may substantially circumscribe the interior I. In some implementations, mechanical fasteners 34 may be used to secure the enclosure cover 28 to the enclosure tray 30, although other fastening methodologies (adhesion, etc.) could also be suitable for this purpose.

Designers may desire to secure one or more peripheral components to the outer enclosure assembly 24 of the traction battery pack 18. Exemplary peripheral components include but are not limited to pressure relief valves, pressure equalization valves, coolant bulkheads or other fittings, etc. Mounting the peripheral components to certain exterior walls of the outer enclosure assembly 24 can be difficult due at least in part to the underbody mounting location of the traction battery pack 18. For example, various mounting plates, shear plates, and/or other structures may be mounted to or otherwise positioned in close proximity to the traction battery pack 18. In some implementations, these structures could be situated in a manner that significantly impedes access to the exterior walls of the outer enclosure assembly 24, thereby complicating or even preventing installation of the peripheral components from a position outside the outer enclosure assembly. This disclosure is therefore directed to systems and methods that enable the installation of peripheral components from inside the outer enclosure assembly 24 of the traction battery pack 18.

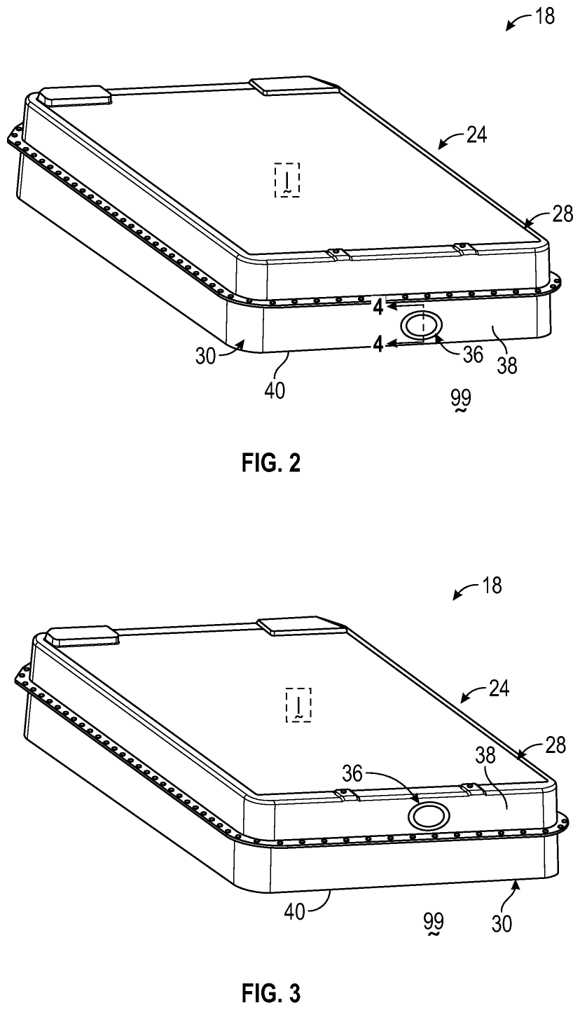

FIG. 2, with continued reference to FIG. 1, illustrates a peripheral component assembly 36 secured to the traction battery pack 18. Although one peripheral component assembly 36 is shown, the traction battery pack 18 could include a greater number of such devices within the scope of this disclosure.

The peripheral component assembly 36 may be disposed within a wall 38 of the outer enclosure assembly 24. In an embodiment, the wall 38 is part of the enclosure tray 30 (see FIG. 2). In another embodiment, the wall 38 is part of the enclosure cover 28 (see FIG. 3). The wall 38 may be any wall, including a floor or bottom wall 40 of the enclosure tray 30, that establishes a portion of an exterior surface of the outer enclosure assembly 24. However, the exact mounting location of each peripheral component assembly 36 could vary and is therefore not intended to limit this disclosure.

The peripheral component assembly 36 may be secured to the wall 38 from inside the traction battery pack 18 (e.g., in an inside-to-outside direction that extends from the interior I of the outer enclosure assembly 24 toward an exterior environment 99 surrounding the traction battery pack 18). As further discussed below, the peripheral component assembly 36 may include twist lock features for facilitating the inside-to-outside installation of the peripheral component assembly 36 to the outer enclosure assembly 24.

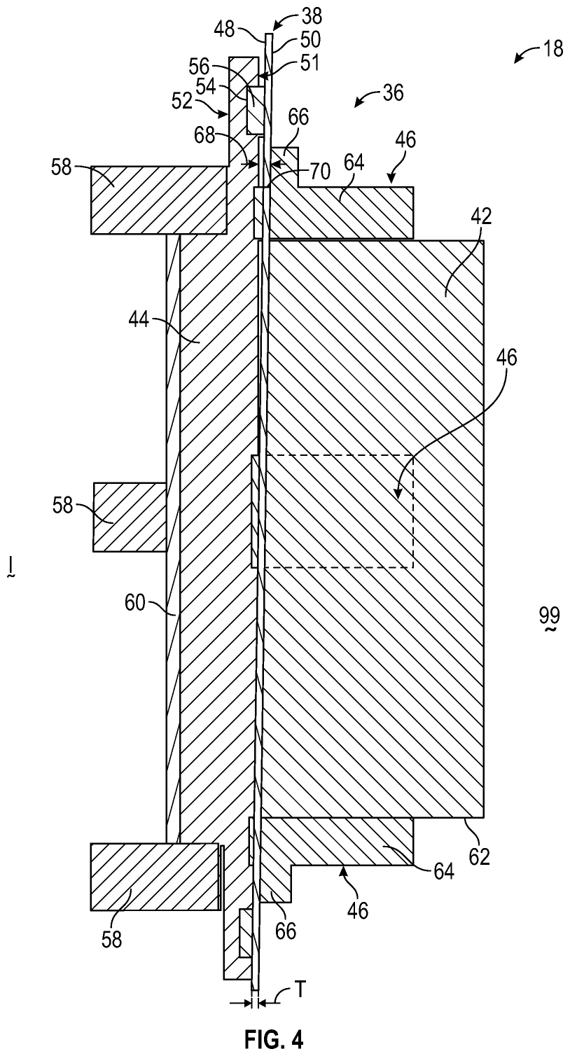

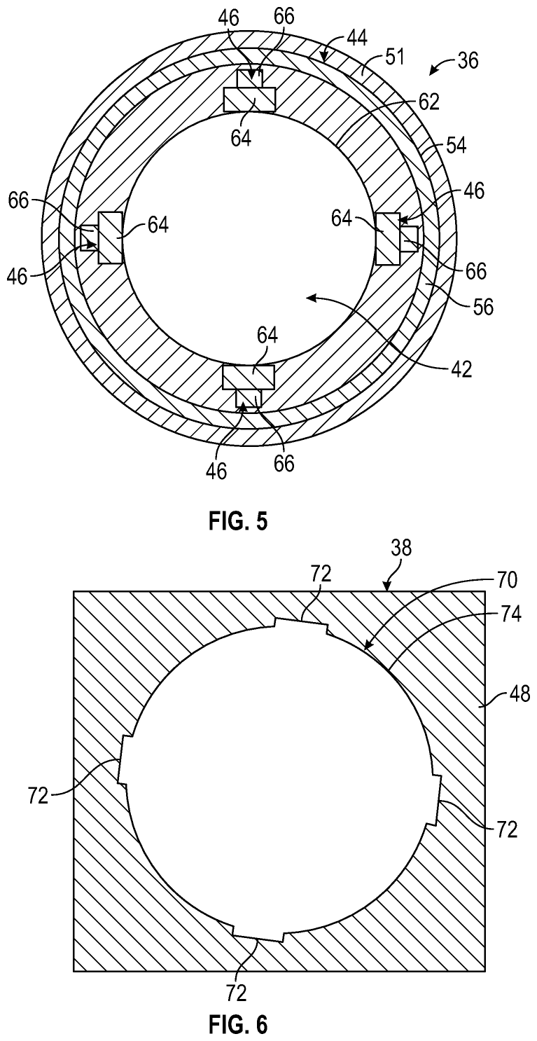

FIGS. 4 and 5, with continued reference to FIGS. 1-2, illustrate features associated with an exemplary peripheral component assembly 36 that can be installed within the wall 38 of the traction battery pack 18. The peripheral component assembly 36 may include a peripheral component body 42, a backing plate 44, and a plurality of twist locks 46. When fully installed, the backing plate 44 may interface with an interior surface 48 of the wall 38, and the twist locks 46 may interface with an exterior surface 50 of the wall 38. The interior surface 48 faces toward the interior I of the traction battery pack 18, and the exterior surface 50 faces in a direction away from the interior I and is thus in fluid communication with the exterior environment 99.

At least a portion of the peripheral component body 42 may protrude outwardly of the exterior surface 50 of the wall 38 in the installed position of the peripheral component assembly 36. Although shown in a highly schematic manner, the peripheral component body 42 may include any necessary subcomponents for performing the intended function of the peripheral component (e.g., valve components, coolant line mounting components, etc.).

The backing plate 44 may include a front surface 51 that interfaces with the interior surface 48 of the wall 38, and a rear surface 52 that is located inwardly from the interior surface 48. In an embodiment, the backing plate 44 is cylindrical shaped (see FIG. 5). However, other shapes are contemplated within the scope of this disclosure.

The front surface 51 may establish a positive stop when installing the peripheral component assembly 36 within a mounting opening 70 of the wall 38. A groove 54 may be formed in the front surface 51, and a face seal 56 may be received within the groove 54. The face seal 56 may be configured to seal the interface between the front surface 51 of the backing plate 44 and the interior surface 48 of the wall 38. The face seal 56 could be a bore seal, an adhesive seal, a press-in-place seal, a carrier gasket, a form-in-place sealant, or any other suitable sealing device/agent.

One or more assembly aids 58 may protrude outwardly from the rear surface 52 of the backing plate 44. The assembly aids 58 may facilitate handling (e.g., by a human hand or a tool) of the peripheral component assembly 36 during its installation. The size, shape, and placement of each assembly aid 58 may be modified to suit any given assembly process.

The peripheral component assembly 36 may further optionally include a block-off plate 60. The block-off plate 60 may be secured to a portion of the backing plate 44 and may be utilized to temporarily seal the peripheral component body 42, such as during a leak check, for example.

The twist locks 46 may protrude outwardly from the front surface 51 of the backing plate 44. In an embodiment, the twist locks 46 are located at a position that is radially inward from the groove 54 and radially outward from a radial outer surface 62 of the peripheral component body 42. However, other configurations are also contemplated. Moreover, the total number of twist locks 46 provided as part of the peripheral component assembly 36 is not intended to limit this disclosure.

Each twist lock 46 may include a base 64 and a mounting tab 66 that extends from the base 64. The mounting tabs 66 may be arranged for facilitating the mounting engagement of the peripheral component assembly 36 to the wall 38. A gap 68 may extend between the front surface 51 of the backing plate 44 and each mounting tab 66. In an embodiment, the size of the gap 68 is about equal to a thickness T of the wall 38. In this disclosure, the term “about” means that the expressed quantities or ranges need not be exact but may be approximated and/or larger or smaller, reflecting acceptable tolerances, conversion factors, measurement error, etc.

The peripheral component assembly 36 may be a polymer-based component. However, one or more subcomponents of the peripheral component assembly 36 could incorporate metallic-based components. Moreover, the peripheral component assembly 36 could embody either a unitary, single-piece structure or a multi-piece structure.

Referring now primarily to FIGS. 4, 6, and 7, the peripheral component assembly 36 may be secured within a mounting opening 70 formed in the wall 38. The mounting opening 70 may be formed through each of the interior surface 48 and the exterior surface 50 of the wall 38 and may include a plurality of radially extending slots 72. The slots 72 may extend radially outward from an outer circumference 74 of the mounting opening 70. Each slot 72 may be sized and shaped to receive the mounting tab 66 of one of the twist locks 46. In an embodiment, the total number of slots 72 provided as part of the mounting opening 70 is equal to the total number of twist locks 46 provided on the peripheral component assembly 36.

To secure the peripheral component assembly 36 within the mounting opening 70, the peripheral component assembly 36 may first be positioned relative to the interior surface 48 of the wall 38 from within the interior I. From the interior I, the peripheral component assembly 36 may be positioned such that each mounting tab 66 of the twist locks 46 aligns with one of the slots 72 of the mounting opening 70. This may be referred to as an alignment position of the peripheral component assembly 36 during the assembly process.

The peripheral component assembly 36 may then be inserted further through the mounting opening 70 until the backing plate 44 abuts against the interior surface 48 of the wall 38. At this position, the mounting tabs 66 and portions of the peripheral component body 42 are positioned outward of the exterior surface 50 of the wall 38.

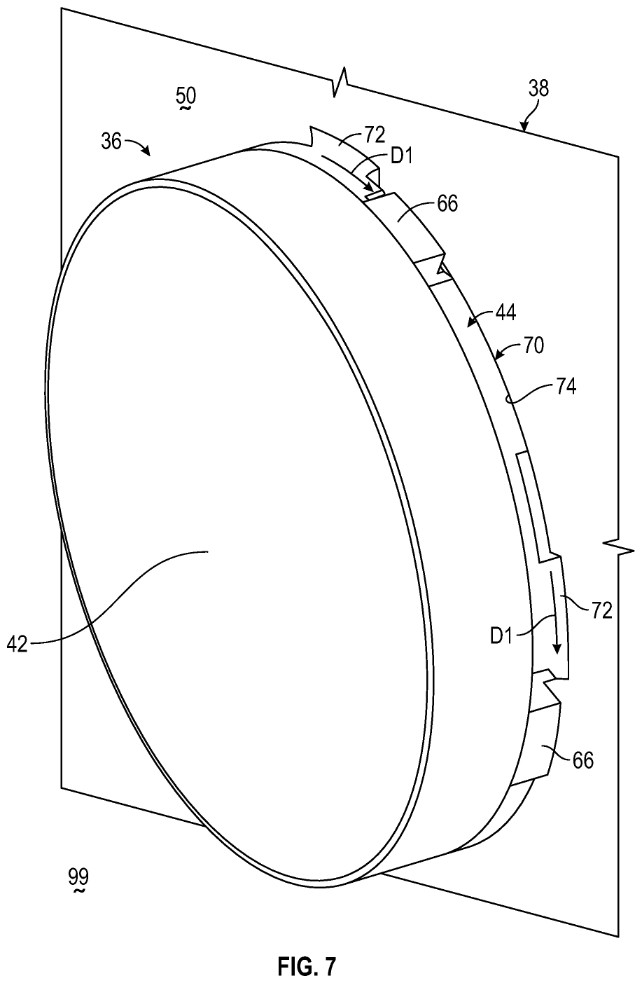

Next, the peripheral component assembly 36 may be rotated in a direction D1 (see FIG. 7), such as a clockwise direction, to secure the peripheral component assembly 36 within the wall 38. Movement in the direction D1 rotates the peripheral component assembly 36, and thus moves the mounting tabs 66 to an engagement position in which the mounting tabs 66 are angularly displaced from the slots 72. In the engagement position, the mounting tabs 66 may engage the exterior surface 50 of the wall 38, thereby preventing the peripheral component assembly 36 from falling back into the interior I through the mounting opening 70.

In general, the mounting tabs 66 may move less than 360 degrees when the peripheral component assembly 36 is rotated between the alignment position and the engagement position. In an embodiment, the mounting tabs 66 may be displaced any amount when moving between the alignment and the engagement positions.

The exemplary traction battery packs of this disclosure incorporate peripheral component assemblies having twist lock features that enable peripheral devices to be efficiently mounted from inside the traction battery pack. The proposed assemblies are relatively simple and inexpensive to assemble and manufacture and do not require complex modifications to the battery pack-to-vehicle mounting strategy.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an outer enclosure assembly including a wall; and
a peripheral component assembly rotatably secured within a mounting opening of the wall,
wherein the peripheral component assembly includes a backing plate that interfaces with an interior surface of the wall and a twist lock that interfaces with an exterior surface of the wall.

2. The traction battery pack as recited in claim 1, wherein the wall is part of an enclosure tray of the outer enclosure assembly.

3. The traction battery pack as recited in claim 1, wherein the wall is part of an enclosure cover of the outer enclosure assembly.

4. The traction battery pack as recited in claim 1, wherein the peripheral component assembly is rotatable between an alignment position and an engagement position relative to the mounting opening.

5. The traction battery pack as recited in claim 4, wherein, in the alignment position, a mounting tab of the twist lock is received within a slot of the mounting opening.

6. The traction battery pack as recited in claim 5, wherein the slot extends radially outward of an outer circumference of the mounting opening.

7. The traction battery pack as recited in claim 5, wherein, in the engagement position, the mounting tab is angularly displaced from the slot and is positioned to engage the exterior surface of the wall.

8. The traction battery pack as recited in claim 1, wherein a gap between the backing plate and a mounting tab of the twist lock is equal to a thickness of the wall.

9. The traction battery pack as recited in claim 1, comprising a plurality of assembly aids that protrude from the backing plate.

10. The traction battery pack as recited in claim 1, wherein the backing plate includes a groove, and comprising a face seal received within the groove and configured to seal an interface between the backing plate and the interior surface of the wall.

11. The traction battery pack as recited in claim 1, comprising a block-off plate removably secured to the backing plate.

12. The traction battery pack as recited in claim 1, wherein the twist lock is located radially outward of a peripheral component body of the peripheral component assembly.

13. The traction battery pack as recited in claim 12, wherein at least a portion of the peripheral component body extends outward of the exterior surface of the wall.

14. The traction battery pack as recited in claim 1, comprising a battery array housed within an interior established by the outer enclosure assembly.

15. The traction battery pack as recited in claim 14, wherein the backing plate is closer to the battery array than the twist lock when the peripheral component assembly is secured within the mounting opening.

16. A method, comprising:
positioning a peripheral component assembly relative to an interior surface of a wall of an outer enclosure assembly of a traction battery pack;
aligning a twist lock of the peripheral component assembly to a slot of a mounting opening of the wall;
moving the twist lock through the slot; and
rotating the peripheral component assembly to cause the twist lock to engage an exterior surface of the wall.

17. The method as recited in claim 16, wherein, after the rotating, a mounting tab of the twist lock is angularly displaced relative to the slot.

18. The method as recited in claim 17, wherein, before the rotating, the mounting tab is aligned with the slot.

19. The method as recited in claim 16, wherein moving the twist lock through the slot includes moving the peripheral component assembly in an inside-to-outside direction relative to an interior of the outer enclosure assembly.

20. The method as recited in claim 19, wherein moving the peripheral component assembly includes positioning a backing plate of the peripheral component assembly in abutting contact with the interior surface of the wall.
